(19) United States
(12) Patent Application Publication
(10) Pub. No.: US 2025/0131094 A1
(43) Pub. Date: Apr. 24, 2025

(54) CONTROL DEVICE TO VERIFY ITS OWN FIRMWARE AS WELL AS FIRMWARE OF EXTERNAL DEVICE

(71) Applicant: Nuvoton Technology Corporation, Hsinchu Science Park (TW)

(72) Inventors: Ching-An CHEN, Taoyuan City (TW); Tzu-Lan SHEN, Taoyuan City (TW)

(21) Appl. No.: 18/789,264

(22) Filed: Jul. 30, 2024

(30) Foreign Application Priority Data
Oct. 20, 2023 (TW) 112140091

(51) Int. Cl. G06F 21/57; G06F 11/36

(52) U.S. Cl. CPC G06F 21/575; G06F 11/3604; G06F 2221/034

(57) ABSTRACT

A control device includes a first memory, a second memory, a processing circuit and an input-output interface. The first memory stores a secure-bootloader program code. The second memory stores a first specific program code. The processing circuit performs the secure-bootloader program code to execute a first legality verification on the first specific program code. When the first specific program code passes the first legality verification, the processing circuit performs the first specific program code to generate a verification signal. The input-output interface is configured to output the verification signal to an external device and receives a response signal from the external device. The processing circuit executes a second legality verification on the reply signal. When the reply signal does not pass the second legality check, the processing circuit ignores a request from the external device.

### CROSS REFERENCE TO RELATED APPLICATIONS

This Application claims priority of Taiwan Patent Application No. 112140091, filed on Oct. 20, 2023, the entirety of which is incorporated by reference herein.

### BACKGROUND OF THE INVENTION

### Field of the Invention

The present invention is related to a control device, and more particularly it is related to a control device to verify its own firmware as well as the firmware of an external device.

### Description of the Related Art

With the advancement of science and technology, the concept that everything can be connected to the Internet has slowly been realized in daily life. For example, users can remotely control electrical devices at home using a smartphone. However, if malicious persons or hackers inject malware into electrical devices in users' homes, the user's personal information may be leaked and the use of the electrical devices may be at risk.

### BRIEF SUMMARY OF THE INVENTION

A control device is provided in accordance with an embodiment of the present invention. The control device includes a first memory, a second memory, a processing circuit, and an input-output interface. The first memory stores a secure-bootloader program code. The second memory stores a first specific program code. The processing circuit executes the secure-bootloader program code to perform a first legality check on the first specific program code. When the first specific program code passes the first legality check, the processing circuit executes the first specific program code to generate a verification signal. The input-output interface is configured to provide the verification signal to an external device and receive a reply signal from the external device. The processing circuit performs a second legality check on the reply signal when the reply signal does not pass the second legality check, the processing circuit ignores the request from the external device.

A chain of trust is further provided in the present invention, which includes a root device and a first device. The root device includes a first memory, a second memory, a root processing circuit, and a first input-output interface. The first memory stores a secure-bootloader program code. The second memory stores a first specific program code. The root processing circuit executes the secure-bootloader program code to perform a first legality check on the first specific program code. When the first specific program code passes the first legality check, the root processing circuit executes the first specific program code to generate a first verification signal. The first input-output interface is configured to output the first verification signal and receive a first reply signal. The first device includes a second input-output interface, a third memory, and a first processing circuit. The second input-output interface is configured to receive the first verification signal and output the first reply signal. The third memory stores a second specific program code. The first processing circuit reads the third memory based on the first verification signal to generate the first reply signal. The root processing circuit performs a second legality check on the first reply signal. When the first reply signal does not pass the second legality check, the root processing circuit ignores a request from the first device.

A control method is also provided in the present invention, which is adapted to a chain of trust. The chain of trust at least includes a root device and a first device. The root device includes a one-time programmable memory and an erasable and programmable memory. The one-time programmable memory stores a secure-bootloader program code, and the erasable and programmable memory stores a first specific program code. The control method includes the following steps. The secure-bootloader program code is executed to determine whether the first specific program code passes a first legality check. When the first specific program code passes the first legality check, the first specific program code is executed to generate a first verification signal. The first verification signal is provided to the first device, wherein the first device generates a first reply signal based on the first verification signal. It is determined whether the first reply signal passes a second legality check. When the first reply signal passes the second legality check, commanding the root device to allow the request from the first device.

The control method of the present invention can be implemented through the chain of trust and the control device provided in the present invention, which may be hardware or firmware that can perform specific functions, and may also be included in a recording medium through program code and implemented with specific hardware. When the program code is loaded and executed by an electronic device, processor, computer, or machine, the electronic device, processor, computer, or machine becomes the chain of trust and the control device as provided in the present invention.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A is a schematic diagram of the chain of trust in accordance with an embodiment of the present invention.

FIG. 1B is another schematic diagram of the chain of trust in accordance with another embodiment of the present invention.

FIG. 2 is a schematic diagram of the device in accordance with an embodiment of the present invention.

FIG. 3 is another schematic diagram of the device in accordance with another embodiment of the present invention.

FIG. 4 is a schematic flow chart of the control method in accordance with an embodiment of the present invention.

### DETAILED DESCRIPTION OF THE INVENTION

In order to make the purpose, features and advantages of the present invention more clearly understandable, embodiments are given below and explained in detail with reference to the accompanying drawings. The description of the present invention provides different examples to illustrate the technical features of different implementations of the present invention. The configuration of each component in the embodiment is only for illustration and is not intended to limit the present invention. In addition, the partial repetition of reference numbers in the figures in the embodiments is for simplifying the description and does not imply the correlation between different embodiments.

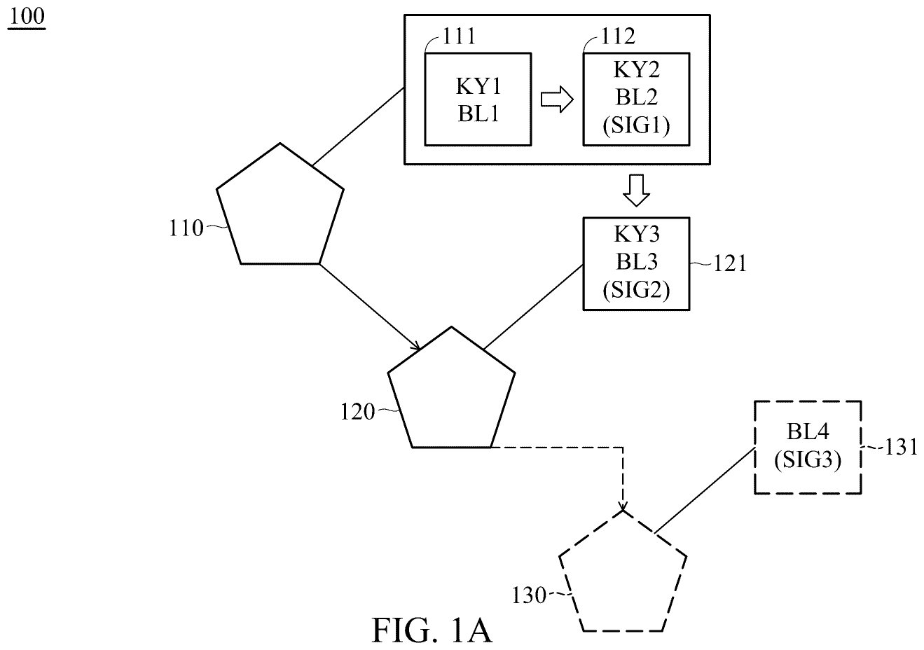

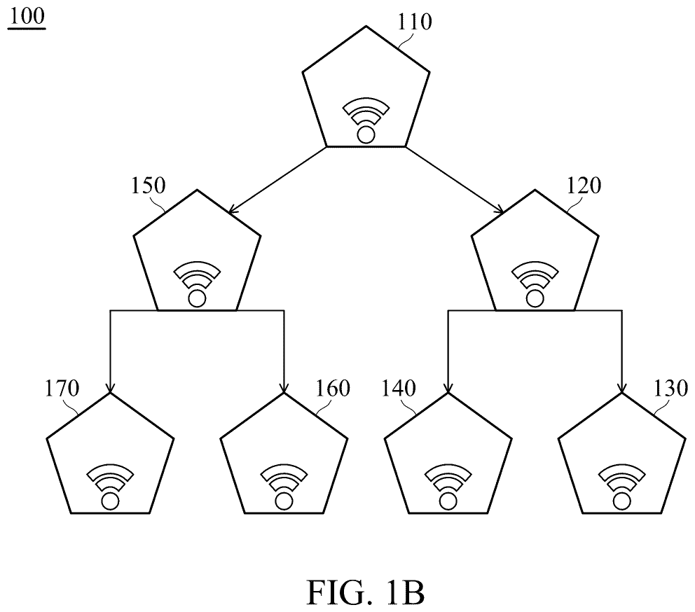

FIG. 1A is a schematic diagram of the chain of trust in accordance with an embodiment of the present invention. As shown in FIG. 1, chain of trust 100 includes devices 110 and 120. The device 110 is located at the uppermost layer of the chain of trust 100, so it can be called as a root device. In this embodiment, the device 110 at least includes memories 111 and 112. The memory 111 at least stores a secure-bootloader program code BL1. In a possible embodiment, the memory 111 further stores a key KY1, but it is not intended to limit the invention. In some embodiments, the key KY1 is stored in another independent memory other than the memory 111.

The present invention is not limited to the type of memory 111. In a possible embodiment, the memory 111 is a non-volatile memory (NVM). In some embodiments, the secure-bootloader program code BL1 is stored in the memory 111 when the memory 111 is shipped from the factory. In this example, the secure-bootloader program code BL1 cannot be cleared or reprogrammed. In a possible embodiment, the memory 111 may be a one-time programmable (OTP) memory, a mask read-only memory (Mask ROM) or a programmable read-only memory (PROM).

The memory 112 stores at least one specific program code BL2. In another possible embodiment, the memory 112 stores firmware required for normal operation of the device 110. The present invention is not limited to the type of memory 112. In a possible embodiment, the memory 112 is a non-volatile memory. For example, the memory 112 may be an Erasable Programmable Read Only Memory (EPROM), an Electrically Erasable Programmable Read-Only Memory (EPROM), or A flash memory.

After the chain of trust 100 is powered on, the device 110 executes the secure-bootloader program code BL1 to verify the legality of the specific program code BL2. In a possible embodiment, the device 110 performs a first legality check on the specific program code BL2 to determine whether the specific program code BL2 has been tampered with. When the specific program code BL2 passes the first legality check, it means that the specific program code BL2 has not been tampered with. Therefore, the device 110 loads and executes the specific program code BL2. After loading the specific program code BL2, the device 110 operates normally. However, when the specific program code BL2 fails the first legality check, it means that the specific program code BL2 has been tampered with. Therefore, the device 110 does not load the specific program code BL2. In a possible embodiment, the device 110 may send a warning message, such as an audio message or an image message.

The present invention does not limit how the device 110 determines whether the specific program code BL2 has been tampered with. In a possible embodiment, the device 110 uses the key KY1 to decrypt a signature SIG1 stored in the memory 112 to generate a first hash value. The device 110 uses a first hash algorithm to process the specific program code BL2 to generate a second hash value. When the first hash value is equal to the second hash value, it means that the specific program code BL2 passes the first legality check. Therefore, the device 110 loads and executes the specific program code BL2.

The present invention does not limit the source of the signature SIG1. In a possible embodiment, a first computing circuit (not shown) uses the same first hash algorithm to process the specific program code BL2 to generate a first specific hash value, and uses a first private key to encrypt the first specific hash value to generate signature SIG1. The first computing circuit then stores the signature SIG1 in the memory 112. In a possible embodiment, the first computing circuit may be integrated in the device 110 or independent from the device 110.

In other embodiments, the device 110 further verifies whether the device 120 is a legal device. When the device 110 loads and executes the specific program code BL2, the device 110 requires the device 120 to provide relevant information about the internal firmware. When the device 110 does not receive the data provided by the device 120 within a predetermined period, the device 110 regards the device 120 as an illegal device and refuses to communicate with the device 120. In another possible embodiment, when the information provided by the device 120 fails the legality check, the device 110 ignores the signal from the device 120.

In a possible embodiment, the device 120 includes a memory 121. The memory 121 stores at least one specific program code BL3. In other embodiments, the memory 121 further stores firmware required for normal operation of the device 120. Since the characteristics of the memory 121 are the same as those of the memory 112, they will not be repeatedly described.

The device 110 determines whether the specific program code BL3 has been tampered with based on the data provided by the device 120. When the specific program code BL3 is not tampered with, this indicates that the device 120 is a legal device. Therefore, device 110 accepts the access request from device 120. However, when the specific program code BL3 is tampered with, this indicates that the device 120 is not a legal device. Therefore, device 110 denies the access request of device 120.

The present invention does not limit how the device 110 determines whether the specific program code BL3 has been tampered with. In a possible embodiment, the memory 112 further stores a key KY2. The key KY2 is configured to verify the specific program code BL3. In this example, the device 110 uses the key KY2 to decrypt a signature SIG2 stored in the memory 121 to generate a third hash value. The device 110 uses a second hash algorithm to process the specific program code BL3 to generate a fourth hash value. When the third hash value is equal to the fourth hash value, it means that the specific program code BL3 passes a second legality check. At this time, since the specific program code BL3 has not been tampered with, the device 110 regards the device 120 as a legal device and accepts the access request from the device 120.

However, when the third hash value is not equal to the fourth hash value, it means that the specific program code BL3 has been tampered with. Therefore, device 110 refuses to communicate with device 120. In a possible embodiment, the device 110 may send a warning message, such as an audio message or an image message. In another possible embodiment, the device 110 updates the specific program code BL3. At this time, the device 110 may provide an initial program code to replace the tampered specific program code BL3.

The present invention does not limit the source of the signature SIG2. In a possible embodiment, a second computing circuit (not shown) uses the same second hash algorithm to process the specific program code BL3 to generate a second specific hash value, and uses a second private key (such as KY3) encrypts the second specific hash value to generate signature SIG2. The second computing circuit then stores the signature SIG2 in the memory 121. In a possible embodiment, the second computing circuit may be integrated in the device 120 or independent from the device 120.

When the specific program code BL3 passes the second legality check, the device 120 loads and executes the specific program code BL3. The present invention does not limit the number of devices 120. In other embodiments, the device 110 is coupled to more devices 120. In this example, whenever one of the devices 120 connects to the device 110, the device 110 first verifies whether the corresponding device 120 is a legal device. Only after the specific program code in the device 120 passes the legality check, the corresponding device 120 has permission to access the device 110. In addition, the present invention does not limit the communication protocol between the devices 110 and 120. The device 110 may communicate with the device 120 using a wired method or a wireless method.

In some embodiments, the chain of trust 100 further includes a device 130. The device 130 includes a memory 131. The memory 131 stores at least one specific program code BL4. In another possible example, the memory 131 stores firmware required for normal operation of the device 130. Since the characteristics of the memory 131 are the same as those of the memory 112, they will not be repeatedly described.

In this embodiment, the device 120 verifies whether the device 130 is a legality device. When the device 120 loads and executes the specific program code BL3, the device 120 requires the device 130 to provide relevant information about the internal firmware. The device 120 determines whether the specific program code BL4 has been tampered with based on the data provided by the device 130. When the specific program code BL4 has not been tampered with, this indicates that the device 130 is a legal device. Therefore, device 120 accepts the access request of device 130. However, when the specific program code BL4 has been tampered with, this indicates that the device 130 is not a legal device. Therefore, device 120 rejects the access request from the device 130. In some embodiments, when the device 120 does not receive data provided by the device 130 within a predetermined period, the device 120 regards the device 130 as an illegal device and ignores signals or requests from the device 130.

The present invention does not limit how the device 120 determines whether the specific program code BL4 has been tampered with. In a possible embodiment, the memory 121 further stores a key KY3. The key KY3 is configured to verify the specific program code BL4. In this example, the device 120 uses the key KY3 to decrypt a signature SIG3 stored in the memory 131 to generate a fifth hash value. The device 120 uses a third hash algorithm to process the specific program code BL4 to generate a sixth hash value. When the fifth hash value is equal to the sixth hash value, it means that the specific program code BL4 passes a third legality check. At this time, since the specific program code BL4 has not been tampered with, the device 120 regards the device 130 as a legal device and accepts the access request from the device 130.

However, when the fifth hash value is not equal to the sixth hash value, it means that the specific program code BLA is tampered with. Therefore, the device 120 rejects the request from device 130. In a possible embodiment, the device 120 reports to the device 110. At this time, the device 110 may send a warning message, such as an audio message or an image message. In another possible embodiment, the device 110 provides an initial program code to the device 130 through the device 120 to update the specific program code BL4.

The present invention does not limit the source of the signature SIG3. In a possible embodiment, a third computing circuit (not shown) uses the same third hash algorithm to process the specific program code BL4 to generate a third specific hash value, and uses a third private key to encrypt the third specific hash value to generate signature SIG3. The third computing circuit then stores the signature SIG3 in the memory 131. In a possible embodiment, the third computing circuit may be integrated in the device 130 or independent from the device 130.

The present invention does not limit the number of devices 130. In other embodiments, the device 120 is coupled to more devices 130. In this example, every time one of the devices 130 connects to the device 120, the device 120 first verifies whether the specific program code BL4 of the corresponding device 130 has been tampered with. Only after the specific program code BLA of the device 130 passes the legality check, the device 130 has permission to access the device 120. In addition, the present invention does not limit the communication protocol between the devices 120 and 130. The device 120 may communicate with the devices 130 using a wired method or a wireless method.

The present invention is not limited to the types of devices 110, 120, and 130. In a possible embodiment, devices 110, 120, and 130 are all Internet of Things (IoT) devices. For example, the device 110 is a wireless base station (WiFi hotspot). In this embodiment, the device 120 may be a hub, and the device 130 may be a home appliance, such as a refrigerator, a television, an air conditioner, etc. The device 110 provides networking services and can be connected to the Internet. When the device 120 is connected to the device 110, it can be connected to the Internet through the device 110.

In this embodiment, the device 110 executes its own secure-bootloader program code BL1 to verify the specific program code BL2. If the specific program code BL2 passes the verification, the device 110 executes the specific program code BL2. When executing the specific program code BL2, the device 110 verifies the device 120. The device 110 may require the device 120 to provide the related information about internal firmware. When the specific program code BL3 of the device 120 has been tampered with, the device 110 ignores the connection request from the device 120. However, when the specific program code BL3 has not been tampered with, the device 110 allows the connection request from the device 120. At this time, the device 120 executes the specific program code BL3.

When executing the specific program code BL3, when the device 130 wants to connect to the device 120, the device 120 first authenticates the device 130. At this time, the device 120 may require the device 130 to provide relevant information about the internal firmware. When the specific program code BL4 of the device 130 cannot pass the legality check, the device 120 may ignore the connection request from the device 130. However, when the specific program code BL4 passes the legality check, the device 120 allows the connection request of the device 130.

In other embodiments, when a device fails verification, the upper-layer device does not provide a connection password to the device, so the device cannot connect to the Internet. Taking the device 120 as an example, when the device 120 passes the verification, the device 110 provides a connection password to the device 120. When the device 120 fails the verification, the device 110 does not provide a connection password to the device 120, so the device 120 cannot connect to the Internet through the device 110. In a possible embodiment, the device 110 sets a different connection password every time it is powered on.

In this embodiment, since the secure-bootloader program code BL1 is stored in a memory that cannot be rewritten, the risk of the secure-bootloader program code BL1 being tempered with can be greatly reduced and the trustworthiness of the secure-bootloader program code BL1 can be ensured. As long as it can pass the legality check of the secure-bootloader program code BL1, it means that the corresponding specific program code (such as BL2) is also trustworthy. Therefore, the specific program code BL2 does not need to be stored in a specific memory (such as MKROM), so component costs can be reduced.

FIG. 1B is another schematic diagram of the chain of trust in accordance with another embodiment of the present invention. FIG. 1B is similar to FIG. 1A, except that the chain of trust 100 further includes devices 140, 150, 160, and 170. The device 110 verifies whether the firmware inside devices 120 and 150 has been tampered with. When the firmware of the device 120 or 150 has been tampered with, the device 110 disconnects the corresponding device. In a possible embodiment, when the device 110 discovers that the firmware of the device 120 or 150 has been tampered with, the device 110 sends a warning message to notify the user.

In this embodiment, the device 120 verifies whether the firmware inside the devices 130 and 140 has been tampered with. When the firmware of devices 130 and 140 has been tampered with, the device 120 disconnects the corresponding device. In one possible embodiment, the device 120 reports the tampering event to the device 110. In another possible embodiment, the device 120 updates the firmware of the tampered device. The device 120 may initialize the tampered device to restore the device's firmware to an initial state.

For example, when the device 130 is coupled to the device 120, the device 120 sends a verification signal (or a second verification signal) to verify whether the device 130 is a legal device. In this example, the device 130 provides a second reply signal based on the second check signal. The device 120 performs a third legality check on the second reply signal. When the second reply signal passes the third legality check, the device 120 accepts the request from the device 130. When the second reply signal fails the third legality check, the device 120 rejects the request from the device 130.

Similarly, when the device 140 is coupled to the device 120, the device 120 sends a verification signal (or a third verification signal) to verify whether the device 140 is a legal device. In this example, the device 140 provides a third reply signal based on the third verification signal. The device 120 performs a fourth legality check on the third reply signal. When the third reply signal passes a fourth legality check, the device 120 accepts the request of the device 140. When the third reply signal fails the fourth legality check, the device 120 rejects the request of the device 140.

The device 150 verifies whether the firmware inside devices 160 and 170 has been tampered with. Since the operation of the device 150 is similar to the operation of the device 120, details will not be repeatedly described. In this embodiment, the devices 110 to 170 are connected wirelessly. When the firmware of a device is tampered with, the upper-layer device disconnects the tampered device, thus preventing malicious software from intruding into the chain of trust 100. Only devices that have been verified to be legal can run on the chain of trust 100, so the security of the chain of trust can be ensured.

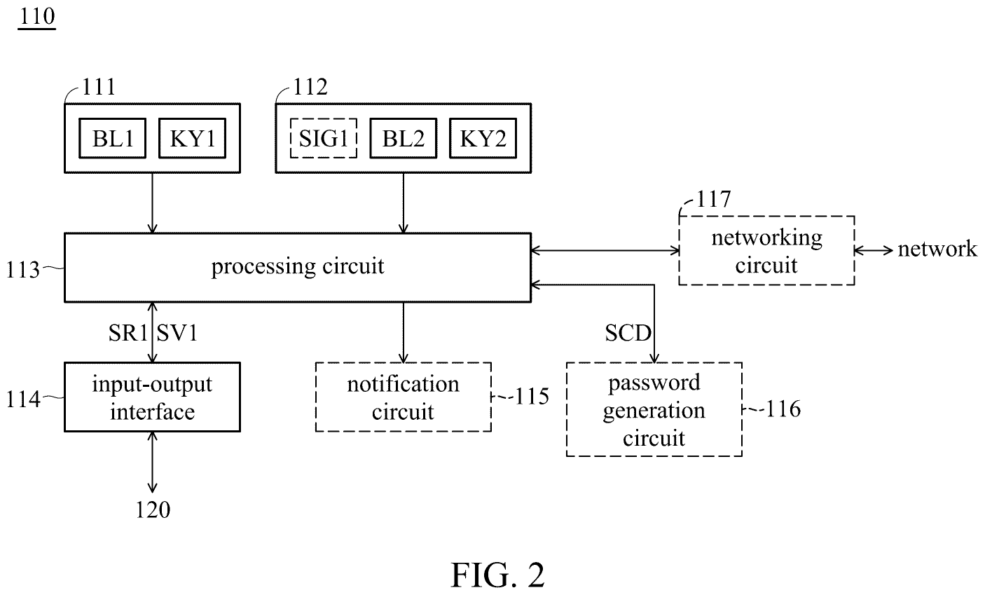

FIG. 2 is a schematic diagram of the device 110 in accordance with an embodiment of the present invention. As shown in FIG. 2, the device 110 (or called control device) includes memories 111, 112 and a processing circuit 113. The memory 111 stores the secure-bootloader program code BL1 and a key KY1, but is not used to limit the present invention. In some embodiments, the key KY1 is stored in another independent memory other than the memory 111.

The memory 112 stores a specific program code BL2 and a key KY2, but it is not used to limit the present invention. In other embodiments, the key KY2 is stored in another independent memory outside the memory 112. In some embodiments, the memory 112 further stores a signature SIG1.

The processing circuit 113 (or root processing circuit) executes the secure-bootloader program code BL1 to perform a first legality check on the specific program code BL2. When the specific program code BL2 passes the first legality check, the processing circuit 113 executes the specific program code BL2 to generate a verification signal SV1. The present invention does not limit the architecture of the processing circuit 113. In a possible embodiment, the processing circuit 113 is composed of logic circuits. In other embodiments, the processing circuit 113 is a central processing unit (CPU).

The present invention does not limit how the processing circuit 113 verifies the specific program code BL2. In a possible embodiment, the processing circuit 113 uses the key KY1 to decrypt the signature SIG1 to generate a first hash value. The processing circuit 113 processes the specific program code BL2 to generate a second hash value. When the first hash value is not equal to the second hash value, it means that the specific program code BL2 fails the first legality check. Therefore, the processing circuit 113 does not load the specific program code BL2. When the first hash value is equal to the second hash value, it means that the specific program code BL2 passes the first legality check. Therefore, the processing circuit 113 loads the specific program code BL2. In a possible embodiment, when the processing circuit 113 executes the specific program code BL2, the processing circuit 113 generates a verification signal SV1.

In other embodiments, the device 110 further includes an input-output interface 114. The input/output interface 114 is used to output the verification signal SV1 to the device 120 and receive a reply signal SR1 generated by the device 120. The present invention does not limit the type of the input/output interface 114. In a possible embodiment, the input-output interface 114 has a wireless transceiver for transmitting the verification signal SV1 and the reply signal SR1. In another possible embodiment, the input-output interface 114 is a general-purpose input/output (GPIO) interface.

In a possible embodiment, when the input-output interface 114 is coupled to an external device (such as the device 120), the processing circuit 113 requires the device 120 to provide relevant information about the internal firmware through the verification signal SV1. The device 120 uses its own firmware data as the reply signal SR1 based on the verification signal SV1, and provides the reply signal SR1 to the input-output interface 114. In this example, the processing circuit 113 performs a legality check on the reply signal SR1. When the reply signal SR1 passes a legality check, this indicates that the device 120 is a legal device. Therefore, processing circuit 113 communicates with device 120.

However, when the reply signal SR1 fails a legality check, this indicates that the device 120 is not a legal device. Therefore, processing circuit 113 rejects the request from device 120. In a possible embodiment, the processing circuit 113 suspends communication with the device 120. In other embodiments, when the reply signal SR1 fails the legality check, the processing circuit 113 updates the firmware data of the device 120 through the input-output interface 114.

In other embodiments, the device 110 further includes a notification circuit 115. The notification circuit 115 is coupled to the processing circuit 113. When the specific program code BL2 fails the legality check, the processing circuit 113 triggers the notification circuit 115. Therefore, the notification circuit 115 sends a notification message. In a possible embodiment, the notification message is an audio message or an image signal. For example, the notification circuit 115 may be a speaker, a lighting device (such as an LED), or a screen.

In some embodiments, the device 110 further includes a password generation circuit 116. When the reply signal SR1 provided by the device 120 passes the legality check, the processing circuit 113 triggers the password generation circuit 116. The password generation circuit 116 generates a connection password SCD. The password generation circuit 116 may directly provide the connection password SCD to the input interface 114. The input-output interface 114 outputs the connection password SCD to the device 120. In another possible embodiment, the password generation circuit 116 provides the connection password SCD to the processing circuit 113. In this example, the processing circuit 113 outputs the connection password SCD to the device 120 through the input interface 114.

In other embodiments, the device 110 further includes a networking circuit 117. The networking circuit 117 is used to connect to an Internet. In this example, the device 120 uses the connection password SCD to connect to the Internet through the processing circuit 113 and the networking circuit 117.

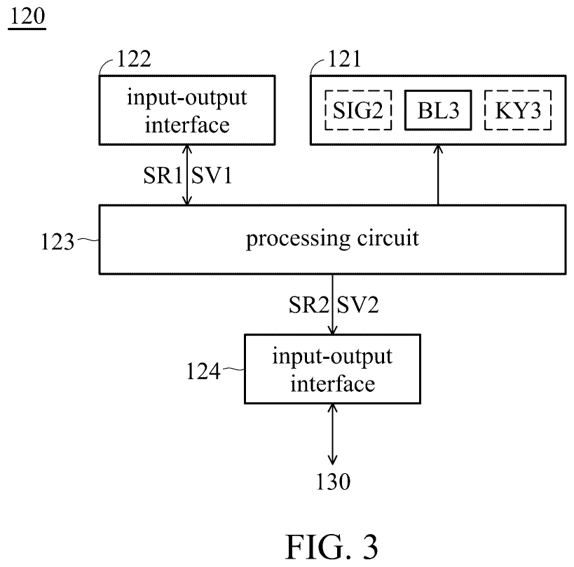

FIG. 3 is another schematic diagram of the device 120 in accordance with another embodiment of the present invention. As shown in the figure, the device 120 includes a memory 121, an input-output interface 122, and a processing circuit 123. The memory 121 stores the specific program code BL3. In a possible embodiment, the memory 121 further stores a signature SIG2. In other embodiments, the memory 121 further stores a key KY3. The key KY3 is used to authenticate an external device (such as device 130). When the device 120 does not need to authenticate other devices, the key KY3 can be omitted. The key KY3 may be stored in another independent memory other than the memory 121.

The input-output interface 122 is used to receive the verification signal SV1 and output the reply signal SR1. The present invention does not limit the type of the input/output interface 122. In a possible embodiment, the input-output interface 122 has a wireless transceiver for transmitting the verification signal SV1 and the reply signal SR1. In another possible embodiment, the input-output interface 122 is a general-purpose input-output interface.

The processing circuit 123 reads the memory 121 based on the verification signal SV1 to generate the reply signal SR1. In a possible embodiment, the processing circuit 123 takes the specific program code BL3 and the signature SIG2 as the reply signal SR1. In some embodiments, the processing circuit 123 executes a specific program code BL3 to generate a verification signal SV2. The present invention does not limit the architecture of the processing circuit 123. In a possible embodiment, the processing circuit 123 is composed of logic circuits. In other embodiments, the processing circuit 123 is a central processing unit.

In other embodiments, the device 120 further includes an input-output interface 124. When the input-output interface 124 is coupled to an external device (such as the device 130), the processing circuit 123 executes a specific program code BL3 to generate the verification signal SV2. The input-output interface 124 outputs the verification signal SV2 to the device 130 to request the device 130 to provide relevant information about the internal firmware. The device 130 uses its own firmware data as the reply signal SR2 based on the verification signal SV2, and provides the reply signal SR2 to the input-output interface 124. In this example, the processing circuit 123 performs a legality check on the reply signal SR2. When the reply signal SR2 passes a legality check, this indicates that the device 130 is a legal device. Therefore, the processing circuit 123 communicates with the device 130.

When the reply signal SR2 fails a legality check, this indicates that the device 130 is not a legal device. Therefore, the processing circuit 123 ignores the request from the device 130. In a possible embodiment, the processing circuit 123 notifies the processing circuit 113 in FIG. 2. In this example, the processing circuit 113 may initialize the device 130 through the device 120.

In some embodiments, the device 130 has an input-output interface (not shown), a memory, and a processing circuit. In this example, the input-output interface of the device 130 is used to receive the verification signal SV2 and output the reply signal SR2. The memory of the device 130 stores at least a third specific program code. The processing circuit of the device 130 reads the corresponding memory based on the verification signal SV2 to provide the reply signal SR2. Since the input-output interface, the memory and the processing circuit of the device 130 are similar to the input-output interface 122, memory 121, and processing circuit 123 of the device 120, the structure of the device 130 will not be described repeatedly.

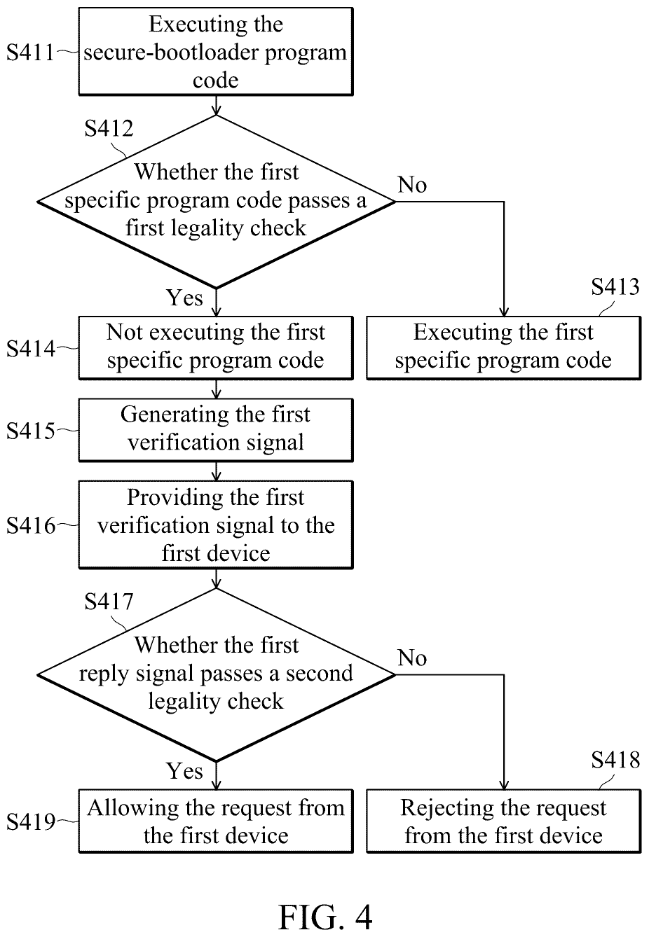

FIG. 4 is a schematic flow chart of the control method in accordance with an embodiment of the present invention. The control method of the present invention can exist by program code. When the program code is loaded and executed by the machine, the machine becomes the chain of trust and implement the control device provided in the invention. In a possible embodiment, the chain of trust includes a root device and a first device. The root device includes a one-time programmable memory and an erasable and programmable memory. The one-time programmable memory stores a secure-bootloader program code. The erasable and programmable memory stores a first specific program code.

First, the secure-bootloader program code is executed to verify the first specific program code (Step S411). In one possible embodiment, the erasable and programmable memory further stores a signature. In this example, Step S411 uses a first key to decrypt the signature to generate a first hash value. Step S411 uses a first hash algorithm to process the first specific program code to generate a second hash value.

Next, it is determined whether the first specific program code passes a first legality check (Step S412). In a possible embodiment, Step S412 determines whether the first hash value is the same as the second hash value. When the first hash value is different from the second hash value, it means that the first specific program code fails the first legality check. Therefore, the first specific program code is not executed (Step S413). In a possible embodiment, Step S413 further sends a warning message to notify the user.

However, when the first hash value is the same as the second hash value, it means that the first specific program code passes the first legality check. Therefore, the first specific program code is executed (Step S414). After executing the first specific program code, a first verification signal is generated to verify whether the first device is a legal device (Step S415).

Next, the first verification signal is provided to the first device (Step S416). In a possible embodiment, the first device uses its own firmware information as a first reply signal based on the first verification signal. Then, it is determined whether the first reply signal passes a second legality check (Step S417). In a possible embodiment, Step S417 uses a second key to decrypt a signature of the first reply signal to generate a third hash value. In this example, Step S417 uses a second hash algorithm to process a file information of the first reply signal to generate a fourth hash value.

When the third hash value is different from the fourth hash value, it means that the first reply signal fails the second legality check. Therefore, the root device is commanded to reject the request from the first device (Step S418). In a possible embodiment, the root device updates the firmware of the first device. For example, the root device provides an initial firmware to the first device. However, when the third hash value is the same as the fourth hash value, it means that the first reply signal passes the second legality check. Therefore, the root device is allowed to communicate with the first device (Step S419).

In this embodiment, the root device determines whether its own specific program code has been tampered with. If so, the specific program code will not be executed to avoid malicious attacks. After determining that the specific program code has not been tampered with, the root device determines whether an external device (or first device) is a legal device. When the external device's firmware has tampered with, the root device rejects the external device's request. In one possible embodiment, the root device may rewrite the firmware of the external device. When the firmware of the external device has not been tampered with, it means that the external device is a legal device. Therefore, the root device allows the request from external devices.

It should be understood that when an element or layer is referred to as being “coupled” to another element or layer, it may be directly coupled or connected to the other element or layer, or other elements or layers intervening may be between them. Conversely, if one element or layer is “connected” to another element or layer, there will be no intervening elements or layers.

The control method of the present invention, or a specific type or part thereof, may exist in the form of program code. Program code can be stored in physical media, such as floppy disks, optical discs, hard disks, or any other machine-readable (such as computer-readable) storage media, or computer program products that are not limited to external forms. When the program code is loaded and executed by a machine, such as a computer, the machine becomes the chain of trust and control device (or called as root device) used to participate in the present invention. Program code can also be transmitted through some transmission media, such as wires or cables, optical fiber, or any transmission type. When the program code is received, loaded and, executed by a machine, such as a computer, the machine becomes the chain of trust and control device that are participated in the present invention. When implemented in a general-purpose processing unit, the program code combined with the processing unit provides a unique device that operates similarly as an application specific logic circuit.

Unless otherwise defined, all words (including technical and scientific words) herein belong to the common understanding of those with ordinary knowledge in the technical field to which the present invention belongs. In addition, unless explicitly stated, the definition of a word in a general dictionary should be interpreted as consistent with its meaning in articles in the relevant technical field, and should not be interpreted as an ideal state or an overly formal tone. Although terms such as “first,” “second,” and the like may be used to describe various elements, these elements should not be limited by these terms. These terms are only used to distinguish one element from another element.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A control device, comprising:
a first memory, storing a secure-bootloader program code;
a second memory, storing a first specific program code;
a processing circuit, executing the secure-bootloader program code to perform a legality check on the first specific program code, wherein when the first specific program code passes the first legality check, the processing circuit executes the first specific program code to generate a first verification signal; and
an input-output interface, configured to output the verification signal to an external device and receive a reply signal from the external device;
wherein the processing circuit performs a second legality check on the reply signal;
wherein when the reply signal does not pass the second legality check, the processing circuit ignores a request from the external device.

2. The control device as defined in claim 1, wherein the first memory is a non-volatile memory and the second memory is a flash memory.

3. The control device as defined in claim 2, wherein the non-volatile memory is a one-time programmable memory or a mask read-only memory.

4. The control device as defined in claim 1, further comprising:
a notification circuit, generating a notification message when the first specific program code does not pass the first legality check;
wherein the notification message is an audio message or an image message.

5. The control device as defined in claim 1, further comprising:
a password generation circuit, generating a connection password when the reply signal passes the second legality check;
wherein the input-output interface provides the connection password to the external device.

6. The control device as defined in claim 1, wherein the first memory further stores a first key and the second memory further stores a second key and a first signature, wherein the processing circuit uses the first key to decrypt the first signature to generate a first hash value, wherein the processing circuit processes the first specific program code to generate a second hash value, wherein when the first hash value is equal to the second hash value, it indicates that the first specific program code passes the first legality check.

7. The control device as defined in claim 6, wherein the reply signal comprises a second specific program code and a second signature, wherein the processing circuit uses the second key to decrypt the second signature to generate a third hash value, wherein the processing circuit processes the second specific program code to generate a fourth hash value, wherein the third hash value is equal to the fourth hash value, indicating that the reply signal passes the second legality check.

8. The control device as defined in claim 7, wherein the processing circuit further updates the second specific program code when the reply signal does not pass the second legality check.

9. A chain of trust, comprising:
a root device, comprising:
a first memory, storing a secure-bootloader program code;
a second memory, storing a first specific program code;
a root processing circuit, executing the secure-bootloader program code to perform a first legality check on the first specific program code, wherein when the first specific program code passes the first legality check, the root processing circuit executes the first specific program code to generate a first verification signal; and
a first input-output interface, configured to output the first verification signal and receive a first reply signal; and
a first device, comprising:
a second input-output interface, configured to receive the first verification signal and output the first reply signal;
a third memory, storing a second specific program code; and
a first processing circuit, reading the third memory based on the first verification signal to generate the first reply signal;
wherein the root processing circuit performs a second legality check on the first reply signal, wherein when the first reply signal does not pass the second legality check, the root processing circuit ignores a request from the first device.

10. The chain of trust as defined in claim 9, wherein the first memory further stores a first key, and the second memory further stores a second key and a first signature, wherein the root processing circuit uses the first key to decrypt the first signature to generate a first hash value, wherein the root processing circuit processes the first specific program code to generate a second hash value, wherein when the first hash value is equal to the second hash value, it indicates that the first specific program code passes the first legality check.

11. The chain of trust as defined in claim 10, wherein the third memory further stores a second signature, and the first processing circuit takes the second specific program code and the second signature as the first reply signal;
wherein the root processing circuit uses the second key to decrypt the second signature to generate a third hash value;
wherein the root processing circuit processes the second specific program code to generate a fourth hash value;
wherein when the third hash value is equal to the fourth hash value, it indicates that the first reply signal passes the second legality check.

12. The chain of trust as defined in claim 11, further comprising:
a second device, coupled to the first device and providing a second reply signal to the first device based on a second verification signal, wherein the first processing circuit performs a third legality check on the second reply signal, wherein when the second reply signal does not pass the third legality check, the first processing circuit ignores a request from the second device.

13. The chain of trust as defined in claim 12, wherein when the second reply signal does not pass the third legality check, the first processing circuit notifies the root processing circuit.

14. The chain of trust as defined in claim 12, wherein the first processing circuit executes the second specific program code to generate the second verification signal.

15. The chain of trust as defined in claim 14, wherein the second device comprises:
a third input-output interface, configured to receive the second verification signal and output the second reply signal;
a fourth memory, storing a third specific program code; and
a second processing circuit, generating the second reply signal based on the third specific program code and providing the second reply signal to the third input-output interface.

16. The chain of trust as defined in claim 11, further comprising:
a third device, coupled to the first device and providing a third reply signal to the first device based on a third verification signal;
wherein the first processing circuit performs a fourth legality check on the third reply signal;
wherein when the third reply signal does not pass the fourth legality check, the first processing circuit ignores a request from the third device;
wherein the first processing circuit executes the second specific program code to generate the third legality check.

17. The chain of trust as defined in claim 9, wherein the first memory is a one-time programmable memory, and the second memory and the third memory are erasable and programmable memories.

18. A control method adapted to a chain of trust, wherein the chain of trust at least comprises a root device and a first device, wherein the root device comprises a one-time programmable memory and an erasable and programmable memory, wherein the one-time programmable memory stores a secure-bootloader program code, and the erasable and programmable memory stores a first specific program code, wherein the control method comprises:
executing the secure-bootloader program code to determine whether the first specific program code passes a first legality check;
when the first specific program code passes the first legality check, executing the first specific program code to generate a first verification signal;
providing the first verification signal to the first device, wherein the first device generates a first reply signal based on the first verification signal;
determining whether the first reply signal passes a second legality check; and
when the first reply signal passes the second legality check, commanding the root device to allow a request from the first device.

19. The control method as defined in claim 18, wherein when the first specific program code does not pass the first legality check, the first specific program code stops running and a warning message is sent.

20. The control method as defined in claim 18, further comprising:
when the first reply signal does not pass the second legality check, commanding the root device to update firmware of the first device.
